(19) United States
(12) Patent Application Publication
(10) Pub. No.: US 2025/0097401 A1
(43) Pub. Date: Mar. 20, 2025

(54) DISPLAY DEVICE

(71) Applicant: SAMSUNG DISPLAY CO., LTD., YONGIN-SI (KR)

(72) Inventors: Young Soo HWANG, Yongin-si (KR); Seong Joo LEE, Yongin-si (KR)

(21) Appl. No.: 18/829,888

(22) Filed: Sep. 10, 2024

(30) Foreign Application Priority Data
Sep. 19, 2023 (KR) 10-2023-0125106

(51) Int. Cl. H04N 13/359; G02F 1/133; G09G 3/00; H04N 13/315; H04N 13/398

(52) U.S. Cl. CPC H04N 13/359; G02F 1/13306; H04N 13/315; H04N 13/398; G09G 3/003; G09G 2320/0257

(57) ABSTRACT

A display device includes: pixels; a first electrode located on the pixels; a liquid crystal layer located on the first electrode; a second electrode located on the liquid crystal layer; a lens array located on the second electrode; and a control circuit including a first node electrically connected to the first electrode and a second node electrically connected to the second electrode. In a first mode, the control circuit applies a first node voltage to the first node, and applies, to the second node, a second node voltage which alternates a high level higher than a voltage level of the first node voltage and a low level lower than the voltage level of the first node voltage. In a second mode, the control circuit allows the first node and the second node to be short-circuited.

### CROSS-REFERENCE TO RELATED APPLICATION

The present application claims priority under 35 U.S.C. § 119(a) to Korean patent application No. 10-2023-0125106, filed on Sep. 19, 2023, in the Korean Intellectual Property Office, the entire disclosure of which is incorporated herein by reference.

### BACKGROUND

### 1. Technical Field

The present disclosure generally relates to a display device.

### 2. Related Art

With the development of information technologies, the importance of a display device, which is a connection medium between a user and information, increases. Accordingly, display devices such as a liquid crystal display device and an organic light emitting display device are increasingly used.

A three-dimensional (3D) image display device is a display device which provides an aspect, such that a user feels a 3D effect by stimulating a visual sense of a real object to the user. For example, the 3D image display device provides different images to left and right eyes of the user, so that the user can view a 3D image due to a binocular parallax between the left and right eyes. The 3D image display device may provide a multi-view image.

Recently, display devices have been developed, which can perform conversion between a 3D mode for displaying a 3D image and a two-dimensional (2D) for displaying a 2D image.

### SUMMARY

Embodiments provide a display device capable of reducing or preventing a delay phenomenon occurring in conversion from a three-dimensional (3D) display mode to a two-dimensional (2D) display mode.

In accordance with an aspect of the present disclosure, there is provided a display device including: a first electrode; a liquid crystal layer located on the first electrode; a second electrode located on the liquid crystal layer; a lens array located on the second electrode; and a control circuit including a first node electrically connected to the first electrode and a second node electrically connected to the second electrode, wherein, in a first mode, the control circuit is configured to apply a first node voltage to the first node, and is configured to apply a second node voltage to the second node, wherein the second node voltage alternates between a high level voltage higher than a voltage level of the first node voltage and a low level voltage lower than the voltage level of the first node voltage, and wherein, in a second mode, the control circuit is configured to short-circuit the first node and the second node.

The first mode may be a three-dimensional (3D) mode, and the second mode may be a two-dimensional (2D) mode.

The control circuit may include: a first resistor including a first electrode configured to receive a first voltage; a second resistor including a first electrode configured to receive the first voltage; a first transistor including a base/gate electrode electrically connected to a second electrode of the first resistor, a first electrode electrically connected to the second node, and a second electrode electrically connected to the first node; and a second transistor including a base/gate electrode electrically connected to a second electrode of the second resistor, a first electrode configured to receive a second voltage, and a second electrode electrically connected to the second node.

Each of the first transistor and the second transistor may be a Bipolar Junction Transistor (BJT).

The first transistor may be a PNP transistor, and the second transistor may be an NPN transistor.

The first node may be electrically connected to a ground.

The first node may be electrically connected to a voltage source different from a ground.

The voltage source may supply a voltage having a voltage level higher than a voltage level of the ground in the first mode and the second mode.

The low level voltage of the second node voltage may be equal to the voltage level of the ground. The voltage level of the voltage supplied from the voltage source may be equal to the voltage level of the ground in a turn-off state of the display device.

The first voltage may maintain a high level voltage in the first mode and maintain a low level voltage in the second mode.

In accordance with an aspect of the present disclosure, there is provided a display device including: a first electrode; a liquid crystal layer on the first electrode; a second electrode on the liquid crystal layer; a first node electrically connected to the first electrode; a second node electrically connected to the second electrode; and a control circuit, wherein the control circuit includes a first transistor including a base/gate electrode configured to receive a first voltage, a first electrode configured to receive a second voltage, and a second electrode electrically connected to the second node, a second transistor including a base/gate electrode configured to receive a third voltage, a first electrode configured to receive the second voltage, and a second electrode electrically connected to the second node; and a third transistor including a base/gate electrode configured to receive the third voltage, a first electrode electrically connected to the second node, and a second electrode electrically connected to the first node, wherein, in a first mode, the control circuit is configured to apply a first node voltage to the first node, and is configured to apply a second node voltage to the second node, wherein the second node voltage alternates between a high level voltage higher than a voltage level of the first node voltage and a low level voltage lower than the voltage level of the first node voltage, and wherein, in a second mode, the control circuit is configured to short-circuit the first node and the second node.

The control circuit may further include: a first inverter including an input terminal configured to receive the second voltage; and a second inverter including an input terminal electrically connected to an output terminal of the first inverter, and an output terminal electrically connected to the first electrode of the first transistor and the first electrode of the second transistor.

Each of the first transistor, the second transistor, and the third transistor may be a Metal Oxide Semiconductor Field Effect Transistor (MOSFET).

The first transistor may be an NMOS transistor, the second transistor may be a PMOS transistor, and the third transistor may be an NMOS transistor.

The first node may be electrically connected to a ground.

The first node may be electrically connected to a voltage source different from a ground.

The voltage source may be configured to supply a voltage having a voltage level higher than a voltage level of the ground in the first mode and the second mode.

The low level voltage of the second node voltage may be equal to the voltage level of the ground. The voltage level of the voltage supplied from the voltage source may be equal to the voltage level of the ground in a turn-off state of the display device.

The third voltage may be a reversed voltage of the first voltage.

In accordance with an aspect of the present disclosure, there is provided a display device including: a first electrode; a liquid crystal layer on the first electrode; a second electrode on the liquid crystal layer; a first node electrically connected to the first electrode; a second node electrically connected to the second electrode; and a control circuit, wherein the control circuit includes a first transistor including a base/gate electrode configured to receive a first voltage, a first electrode configured to receive a second voltage, and a second electrode electrically connected to the second node, a second transistor including a base/gate electrode configured to receive a third voltage, a first electrode configured to receive the second voltage, and a second electrode electrically connected to the second node; and a third transistor including a base/gate electrode configured to receive the third voltage, a first electrode electrically connected to the second node, and a second electrode electrically connected to the first node, wherein, in a first mode, the control circuit is configured to apply a first node voltage to the first node, and is configured to apply a second node voltage to the second node, wherein the second node voltage alternates between a high level voltage higher than a voltage level of the first node voltage and a low level voltage lower than the voltage level of the first node voltage, and wherein, in a second mode, the control circuit is configured to short-circuit the first node and the second node, and wherein the first voltage may maintain a high level voltage in the first mode and maintain a low level voltage in the second mode.

### BRIEF DESCRIPTION OF THE DRAWINGS

Various embodiments will now be described more fully hereinafter with reference to the accompanying drawings, where the same reference numbers identify the same or similar features.

FIG. 1 is a view illustrating a three-dimensional (3D) image display device using a lens array method, according to an embodiment.

FIG. 2 is a view illustrating a relationship between a lens array and a display panel in accordance with an embodiment of the present disclosure.

FIGS. 3 to 5 are views illustrating a display device capable of performing conversion between a 3D mode and a two-dimensional (2D) mode in accordance with an embodiment of the present disclosure.

FIGS. 6 and 7 are diagrams illustrating a mode control circuit and a mode conversion layer, according to an embodiment.

FIGS. 8 to 10 are diagrams illustrating a mode control circuit in accordance with an embodiment of the present disclosure.

FIG. 11 is a diagram illustrating a mode control circuit in accordance with an embodiment of the present disclosure.

FIGS. 12 to 14 are diagrams illustrating mode control circuits in accordance with embodiments of the present disclosure.

### DETAILED DESCRIPTION

Hereinafter, exemplary embodiments are described in detail with reference to the accompanying drawings. The present disclosure may be implemented in various forms and is not limited to the exemplary embodiments described in the present specification.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

In addition, the size and thickness of each component illustrated in the drawings may be exaggerated for better understanding and ease of description, but the present disclosure is not limited thereto.

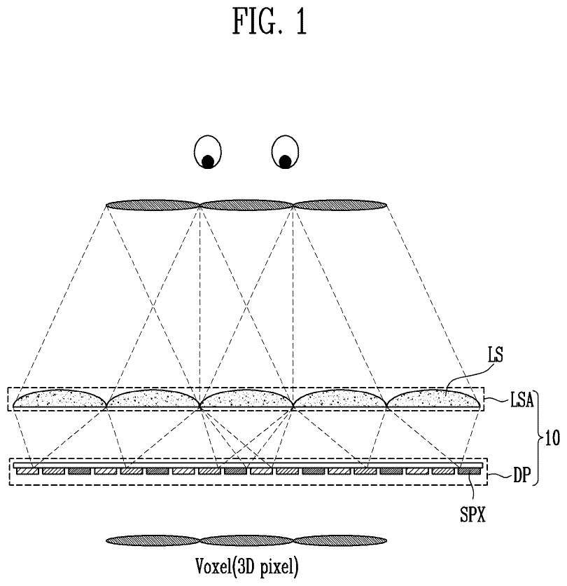

FIG. 1 is a view illustrating a three-dimensional (3D) image display device using a lens array method, according to an embodiment.

Referring to FIG. 1, the 3D image display device 10 may include a display panel DP and a lens array LSA.

In various embodiments, the display panel DP may include sub-pixels SPX, which emit light, thereby displaying an image. In an embodiment, each of the sub-pixels SPX may output light of a first color (e.g., red), light of a second color (e.g., green), or light of a third color (e.g., blue). However, this is merely illustrative, and the color of light emitted from the sub-pixels SPX is not limited thereto. Lights of various colors for full-color implementation may be output. The display panel DP may include an organic light emitting display panel, a liquid crystal display panel, a quantum dot display panel, and the like.

In various embodiments, the lens array LSA may be disposed on the display panel DP, and include lenses LS that refract light incident from the sub-pixels SPX, where the lens array LSA may be implemented as a lenticular lens array, a micro lens array, or the like.

In various embodiments, a light field display is a 3D display which implements a 3D image by forming a light field expressed with a vector distribution (intensity and direction) of light in a space, using a flat panel display and an optical element (e.g., the lens array LSA). The light field display refers to a display technique in which a depth, a side, and the like of an object can be viewed, so that a more natural 3D image can be implemented, thereby expecting various uses through fusion with an Augmented Reality (AR) technique, and the like.

In various embodiments, the light field may be implemented using various methods, where for example, the light field may be formed using a method of making light fields in several directions using several projectors, a method of controlling a direction of light using a grating, a method of controlling a direction and an intensity (luminance) of light according to a combination of pixels using two or more panels, a method of controlling a direction of light using a pinhole or a barrier, a method of controlling a refraction direction of light through a lens array, or the like.

In an embodiment, as shown in FIG. 1, the 3D image display device 10 using a lens array method may form a light field, thereby displaying a stereoscopic image (3D image).

In various embodiments, a series of sub-pixel SPX may be allocated to each of the lenses LS, and light emitted from each of the sub-pixels SPX may be refracted by the lens LS to advance in a specific direction, thereby forming a light field expressed with an intensity and a direction of the light. When a user views the display device 10 in the light field formed as described above, the user can observe a 3D effect of a corresponding image.

Image information, according to a viewpoint of the user within the light field, may be defined and processed in units of voxels. The voxel may be understood as graphic information, which defines a predetermined point (or pixel) in a 3D space.

In various embodiments, a resolution of a two-dimensional (2D) image may be determined based on a number (e.g., a density) of pixels with respect to the same area. For example, when the number of pixels with respect to the same area increases, the resolution may increase. The display panel DP having a high pixel density may be utilized to display a high-resolution image. Similarly, when the number of voxels at the same viewpoint through the lens array LSA increases, the resolution of a 3D image may increase.

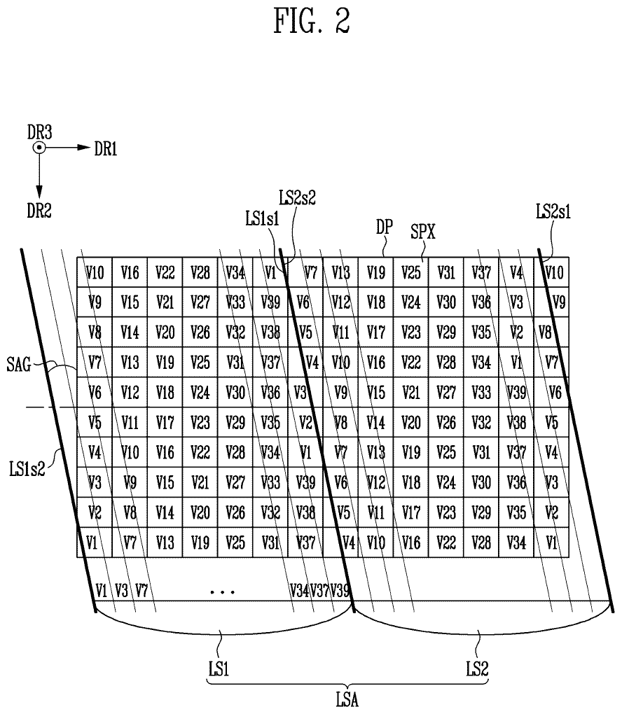

FIG. 2 is a view illustrating a relationship between the lens array and the display panel in accordance with an embodiment of the present disclosure.

In various embodiments, the display panel DP may include sub-pixels SPX arranged in a first direction DR1 and a second direction DR2 perpendicular to the first direction DR1. The sub-pixels SPX may include surfaces emitting light in a third direction DR3 perpendicular to the first direction DR1 and the second direction DR2.

In various embodiments, the lens array LSA may include lenses LS1, LS2, . . . . The lenses LS1, LS2, . . . may overlap with the sub-pixels SPX in the third direction DR3. The lenses LS1, LS2, . . . may be arranged such that long sides thereof have an angle SAG greater than 0 degree with respect to the second direction DR2. For example, the lenses LS1, LS2, . . . may be lenticular lenses. For example, a first lens LS1 may include a first long side LS1s1 and a second long side LS1s2, which are parallel to each other. In addition, a second lens LS2 may include a first long side LS2s1 and a second long side LS2s2, which are parallel to each other. The lenses LS1, LS2, . . . may be arranged in the first direction DR1, where the lenses LS1, LS2, . . . may be arranged parallel to each other. However, in another embodiment, the angle SAG may be 0 degree. When the angle SAG is 0 degree, long sides LS1s1, LS1s2, LS2s1, LS2s2, . . . of the lenses LS1, LS2, . . . may extend in the second direction DR2. The lenses LS1, LS2, . . . may adjoin each other along the long sides thereof.

In various embodiments, a lower surface (e.g., the surface facing the sub-pixels) of each of the lenses LS1, LS2, . . . may be partitioned into a plurality of viewpoint areas V1 to V39. The plurality of viewpoint areas V1 to V39 are not physically partitioned, but are virtual areas. The plurality of viewpoint areas V1 to V39 may be variously defined by a resolution of the display panel DP, a standard of the lenses LS1, LS2, . . . , a number of viewpoints to be provided to a user, and the like. Each of the lenses LS1, LS2, . . . distributes images respectively corresponding to the viewpoint areas V1 to V39 in different directions (different viewpoints), so that the user can view a multi-view image in which an image can vary according to a position.

In various embodiments, the sub-pixels SPX may overlap with one or more of the plurality of viewpoint areas V1 to V39. For example, each of the sub-pixels SPX may be located in relation to each of the plurality of viewpoint areas V1 to V39. Sub-pixels SPX corresponding to the same viewpoint area may display an image for the same viewpoint. For example, because 39 viewpoint areas V1 to V39 exist in FIG. 2, the display panel DP may simultaneously display 39 images.

In various embodiments, the display device 10 may allow sub-pixels SPX overlapping with viewpoints areas V1 to V20 to display a right-eye image and allow sub-pixels SPX overlapping with viewpoints areas V21 to V39 to display a left-eye image, thereby displaying a 3D image to the user located such that the left-eye image is viewed by a left eye of the user and the right-eye image is viewed by a right eye of the user.

In various embodiments, the sub-pixels SPX may be arranged according to various structures, such as RGP stripe, diamond PENTILE™, S-stripe, read RGB, and normal PENTILE™.

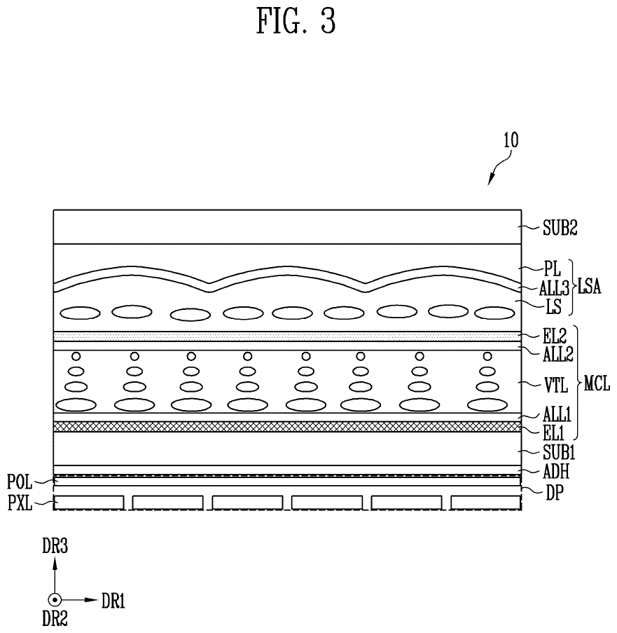

FIGS. 3 to 5 are views illustrating a display device capable of performing conversion between a 3D mode and a 2D mode in accordance with an embodiment of the present disclosure.

Referring to FIG. 3, the display device 10 in accordance with the embodiment of the present disclosure may include a display panel DP, an adhesive layer ADH, a first substrate SUB1, a mode conversion layer MCL, a lens array LSA, and a second substrate SUB2.

In various embodiments, the display panel DP may include an organic light emitting display panel, a liquid crystal display panel, a quantum dot display panel, and the like. The display panel DP may include a pixel layer PXL and a polarizing layer POL.

In various embodiments, the pixel layer PXL may include a plurality of pixels, where a single pixel may include two or more sub-pixels having different colors.

In various embodiments, the polarizing layer POL may be located on the pixel layer PXL, where the polarizing layer POL may serve as an anti-reflection layer. For example, the polarizing layer POL may decrease the reflectance of external light incident from the outside of the display device 10. In various embodiments, the polarizing layer POL may include a retarder or a polarizer. The retarder may be of a film type or a liquid crystal coating type, and include a ½ wavelength retarder or a ¼ wavelength retarder. The polarizer may be of a film type or a liquid crystal coating type.

In various embodiments, the polarizing layer POL is not configured with a polarizing film or a polarizing plate, but may be functionally configured using at least another element included in the display panel DP. For example, a function of the polarizing layer POL may be implemented using a color filter, a black matrix or the like, which is included in the display panel DP.

In various embodiments, the adhesive layer ADH may be located on the display panel DP. The adhesive layer ADH may allow the display panel DP and the first substrate SUB1 to adhere to each other. The adhesive layer ADH may be a transparent adhesive layer, where for example, the adhesive layer ADH may be configured as an Optically Clear Adhesive (OCA) film or an Optically Clear Resin (OCR).

In various embodiments, the first substrate SUB1 may be located on the adhesive layer ADH. The first substrate SUB1 may be formed of a transparent insulating material, for example, the first substrate SUB1 may be formed of an organic material selected from the group consisting of polyethersulphone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose triacetate (SAC), and cellulose acetate propionate (CAP).

In an embodiment, the first substrate SUB1 may be formed of an inorganic material. For example, the first substrate SUB1 may include a silicon nitride layer, a silicon oxynitride layer, a silicon oxide layer, a titanium oxide layer, an aluminum oxide layer, or the like.

In various embodiments, the mode conversion layer MCL may be located on the first substrate SUB1. The mode conversion layer MCL may control whether the display device 10 is to be driven in the 3D mode (i.e., a first mode) or the 2D mode (i.e., a second mode). For example, the mode conversion layer MCL may include a first electrode EL1, a first alignment layer ALL1, a liquid crystal layer VTL, a second alignment layer ALL2, and a second electrode EL2.

In various embodiments, the first electrode EL1 may be located on the first substrate SUB1. The first electrode EL1 may include at least one of a metal material, a transparent conductive material, and other various conductive materials. In an example, the first electrode EL1 may include at least one of various metal materials including gold (Au), silver (Ag), aluminum (Al), molybdenum (Mo), chromium (Cr), titanium (Ti), nickel (Ni), neodymium (Nd), copper (Cu), platinum (Pt), or the like, or alloys thereof. The first electrode EL1 may be configured in a mesh shape including openings exposing the sub-pixels of the pixel layer PXL. Also, the first electrode EL1 may include at least one of various transparent conductive materials including silver nano wire (AgNW), Indium Tin Oxide (ITO), Indium Zinc Oxide (IZO), Indium Gallium Zinc Oxide (IGZO), Antimony Zinc Oxide (AZO), Indium Tin Zinc Oxide (ITZO), Zinc Oxide (ZnO), Tin Oxide (SnO₂), carbon nano tube, graphene, or the like. The first electrode EL1 may include at least one of various conductive materials. The first electrode EL1 may be provided as a single layer or a multi-layer, and the sectional structure thereof is not particularly limited.

In various embodiments, the first alignment layer ALL1 may be located on the first electrode EL1, where for example, the first alignment layer ALL1 may include polyimide. The first alignment layer ALL1 may be rubbing-processed, according to a desired liquid crystal driving mode. Meanwhile, when the first alignment layer ALL1 is applicable at a desired position, using an inkjet technique, the rubbing processing on the first alignment layer ALL1 may be unnecessary.

In various embodiments, the liquid crystal layer VTL may be located on the first alignment layer ALL1. The liquid crystal layer VTL may be configured in a Twisted Nematic (TN) mode having a λ/2 phase difference. However, this is illustrative, and the liquid crystal layer VTL may be configured in a liquid crystal mode, such as Vertical Alignment (VA), Optical Compensated Bend (OCB), or Electrically Controlled Birefringence (ECB).

In various embodiments, the second alignment layer ALL2 may be located on the liquid crystal layer VTL, where for example, the second alignment layer ALL2 may include polyimide. The second alignment layer ALL2 may be rubbing-processed, according to a desired liquid crystal driving mode. Meanwhile, when the second alignment layer ALL2 is applicable at a desired position, using an inkjet technique, the rubbing processing on the second alignment layer ALL2 may be unnecessary.

In various embodiments, the second electrode EL2 may be located on the second alignment layer ALL2. The second electrode EL2 may include at least one of a metal material, a transparent conductive material, and other various conductive materials. In an example, the second electrode EL2 may include one or more various metal materials, including gold (Au), silver (Ag), aluminum (Al), molybdenum (Mo), chromium (Cr), titanium (Ti), nickel (Ni), neodymium (Nd), copper (Cu), platinum (Pt), and the like, or alloys thereof. The second electrode EL2 may be configured in a mesh shape, including openings exposing the sub-pixels of the pixel layer PXL. Also, the second electrode EL2 may include one or more various transparent conductive materials, including silver nano wire (AgNW), Indium Tin Oxide (ITO), Indium Zinc Oxide (IZO), Indium Gallium Zinc Oxide (IGZO), Antimony Zinc Oxide (AZO), Indium Tin Zinc Oxide (ITZO), Zinc Oxide (ZnO), Tin Oxide (SnO₂), carbon nano tube, graphene, and the like. The second electrode EL2 may include at least one of various conductive materials, to have conductivity. Also, the second electrode EL2 may be provided as a single layer or a multi-layer, and the sectional structure thereof is not particularly limited.

In various embodiments, the lens array LSA may be located on the second electrode EL2. The lens array LSA may be implemented in various structures, where for example, the lens array LSA may be implemented as a lenticular lens array, a micro lens array, or the like. The lens array LSA may include lenses LS, a third alignment layer ALL3, and an outer layer PL.

In various embodiments, the lenses LS may include an optically anisotropic material. For example, the inside of the lenses LS may be formed with a reactive mesogen, where the lenses LS may have a mesogenic structure, to form a liquid crystal phase. A material filling in the lenses LS may be formed to have the liquid crystal phase by being cured through reaction with light, such as ultraviolet light. Accordingly, the inside of the lenses LS may have an optically anisotropic fixed phase. For example, the lenses LS may have different major axis refractive indexes and different minor axis refractive indexes.

In various embodiments, the third alignment layer ALL3 may be located on the lenses LS. The third alignment layer ALL3 may include polyimide. The third alignment layer ALL3 may be rubbing-processed, according to a desired liquid crystal driving mode. When the third alignment layer ALL3 is applicable at a desired position, using an inkjet technique, the rubbing processing on the third alignment layer ALL3 may be unnecessary.

In various embodiments, the outer layer PL may be disposed to cover the third alignment layer ALL3. The outer layer PL may have a flat top surface. The outer layer PL may be formed of an optically isotropic polymer. For example, the outer layer PL may include an optically isotropic material having a refractive index substantially equal to the major axis refractive index or the minor axis refractive index of the lenses LS. For example, the isotropic polymer may be selected from the group consisting of acrylic resin, polycarbonate, and cyclo olefin polymer (COP).

In various embodiments, the second substrate SUB2 may be located on the lens array LSA. The second substrate SUB2 may be formed of a transparent insulating material, where for example, the second substrate SUB2 may be formed of an organic material selected from the group consisting of polyethersulphone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose triacetate (SAC), and cellulose acetate propionate (CAP).

In an embodiment, the second substrate SUB2 may be formed of an inorganic material, where for example, the second substrate SUB2 may include a silicon nitride layer, a silicon oxynitride layer, a silicon oxide layer, a titanium oxide layer, an aluminum oxide layer, or the like.

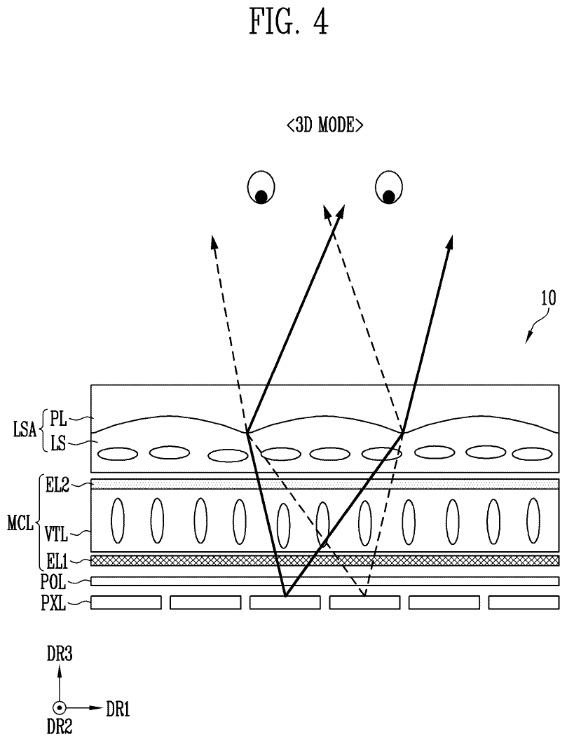

A case where the display device 10 is driven in the 3D mode will be described with reference to FIG. 4. Light emitted from the pixel layer PXL may become input polarized light, through passing through the polarizing layer POL. In response to an electric field formed between the first electrode EL1 and the second electrode EL2, liquid crystal molecules of the liquid crystal layer VTL may become oriented along an electric field direction. Therefore, the input polarized light may be incident into the lens array LSA, while passing through the liquid crystal layer VTL as it is. The alignment direction of liquid crystal molecules of the lenses LS accords with the direction of the input polarized light, so that the refractive index can be maximized due to a maximum retardation effect. Accordingly, a refractive index difference occurs at an interface between the lenses LS and the outer layer PL, so that the lens array LSA can serve as lenses for 3D images. Thus, a 3D image may be displayed.

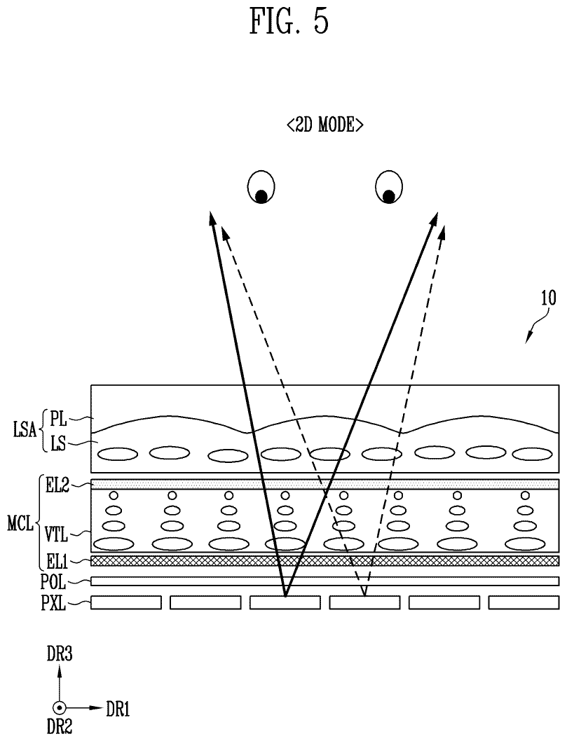

A case where the display device 10 is driven in the 2D mode will be described with reference to FIG. 5. Light emitted from the pixel layer PXL may become input polarized light while passing through the polarizing layer POL. In a state in which an electric field is not formed between the first electrode EL1 and the second electrode EL2, an alignment direction of the liquid crystal molecules of a lower side of the liquid crystal layer VTL is different from an alignment direction of the liquid crystal molecules of an upper side of the liquid crystal layer VTL by 90 degrees. Therefore, the polarization vector of the input polarized light may be rotated by 90 degrees by passing through the liquid crystal layer VTL. The alignment direction of liquid crystal molecules of the lenses LS can be in a state in which the alignment direction is orthogonal to the direction of the propagation vector of the input polarized light, so that the refractive index of the lenses LS can be minimized. Accordingly, a refractive index difference is minimized at an interface between the lenses LS and the outer layer PL, so that the lens array LSA does not serve as lenses for 3D images. Thus, a 2D image may be displayed.

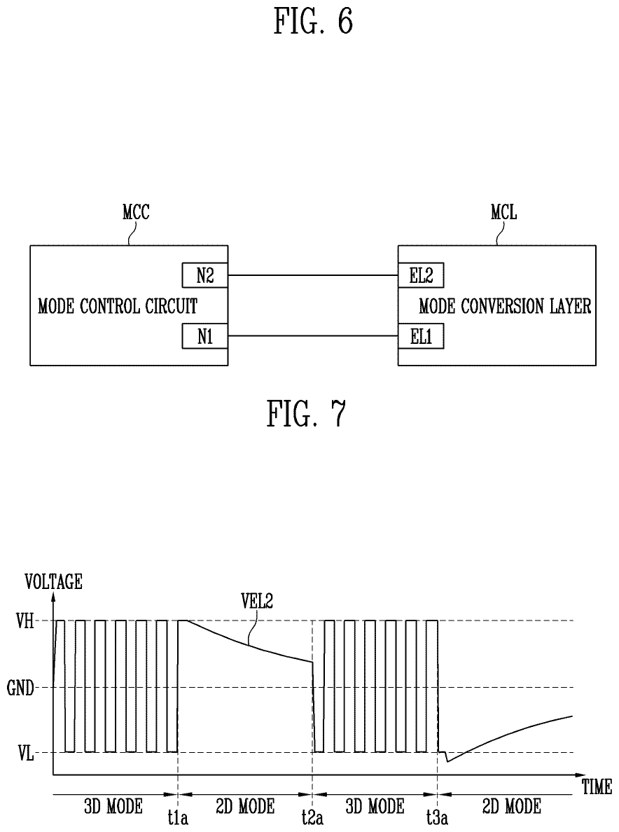

FIGS. 6 and 7 are diagrams illustrating a mode control circuit and a mode conversion layer.

Referring to FIG. 6, a mode control circuit MCC and a mode conversion layer MCL in accordance with an embodiment of the present disclosure are illustrated. As described above with reference to FIG. 3, the mode conversion layer MCL may be located on the pixels, and include a first electrode EL1, a second electrode EL2, and a liquid crystal layer VTL located between the first electrode EL1 and the second electrode EL2.

In various embodiments, the mode control circuit MCC may include a first node N1 electrically connected to the first electrode EL1 and a second node N2 electrically connected to the second electrode EL2 of the mode conversion layer MCL.

In the 3D mode, the mode control circuit MCC may apply a first node voltage to the first node N1, where for example, the first node voltage may have a voltage level of 0V, which corresponds to a ground GND. In the 3D mode, the mode control circuit MCC may apply, a second node voltage to the second node N2, which alternates between a high level voltage VH, which may be higher than the voltage level of the first node voltage, and a low level voltage VL, which may be lower than the voltage level of the first node voltage. For example, the high level VH of the second node voltage may be (+)5V, and the low level VL of the second node voltage may be (−)5V. Referring to FIG. 7, it can be seen that a voltage VEL2 of the second electrode EL2 is substantially equal to the second node voltage of the second node N2 in 3D mode periods (˜t1a, t2a˜t3a). In a first mode, the mode control circuit MCC may be configured to apply a first node voltage to the first node, and may be configured to apply a second node voltage to the second node, wherein the second node voltage may alternate between a high level voltage higher than a voltage level of the first node voltage and a low level voltage lower than the voltage level of the first node voltage. The first mode may be a three-dimensional (3D) mode, and the second mode may be a two-dimensional (2D) mode. The first node may be electrically connected to a ground.

As the voltage VEL2 of the second electrode EL2 alternates between the high level voltage VH and the low level voltage VL, electric fields in different directions may be alternately applied to the liquid crystal layer VTL. When an electric field in the same direction is continuously applied to the liquid crystal layer VTL, ions are accumulated in a specific area of the liquid crystal layer VTL, and therefore, an electric field in the opposite direction may be generated. In accordance with this embodiment, electric fields in different directions are alternately applied to the liquid crystal layer VTL, so that such an accumulation of ions can be prevented.

In the 2D mode, the mode control circuit MCC may suspend the voltage supplied to the second node N2. The voltage VEL2 of the second electrode EL2 may not be immediately changed to a voltage level corresponding to the ground GND. Referring to a 2D mode period t1a to t2a, a delay phenomenon can be seen, in which the voltage VEL2 of the second electrode EL2 slowly increases from the low level VL. This may be a delay phenomenon due to capacitance between the first electrode EL1 and the second electrode EL2. While a voltage difference between the first electrode EL1 and the second electrode EL2 can result from the delay phenomenon, an image in the 2D mode may not be properly implemented. However, a voltage difference between the first electrode EL1 and the second electrode EL2 resulting from the delay phenomenon can be reduced or prevented by using a discharge function.

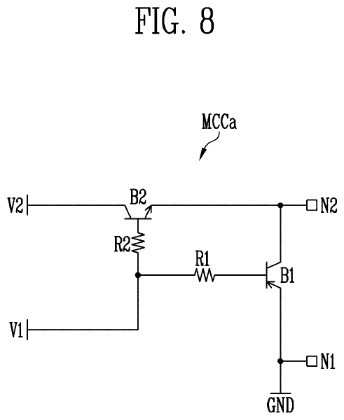

FIGS. 8 to 10 are diagrams illustrating a mode control circuit in accordance with an embodiment of the present disclosure.

Referring to FIG. 8, the mode control circuit MCCa, in accordance with the embodiment of the present disclosure, may include a first resistor R1, a second resistor R2, a first transistor B1, and a second transistor B2. The first resistor R1 and second resistor R2, may be electrically connected between the bases/gates of the first transistor B1 and the second transistor B2.

In various embodiments, a first electrode of the first resistor R1 may receive a first voltage V1, and a second electrode of the first resistor R1 may be connected to a base/gate electrode of the first transistor B1.

In various embodiments, a first electrode of the second resistor R2 may receive the first voltage V1, and a second electrode of the second resistor R2 may be connected to a base/gate electrode of the second transistor B2.

In various embodiments, the base/gate electrode of the first transistor B1 may be connected to the second electrode of the first resistor R1, a first electrode of the first transistor B1 may be connected to a second node N2, and a second electrode of the first transistor B1 may be connected to a first node N1. For example, the first node N1 may be connected to a ground GND.

In various embodiments, the base/gate electrode of the second transistor B2 may be connected to the second electrode of the second resistor R2, a first electrode of the second transistor B2 may receive a second voltage V2, and a second electrode of the second transistor B2 may be connected to the second node N2.

Each of the first transistor B1 and the second transistor B2 may be a Bipolar Junction Transistor (BJT). The first transistor B1 may be a PNP transistor, and the second transistor B2 may be an NPN transistor.

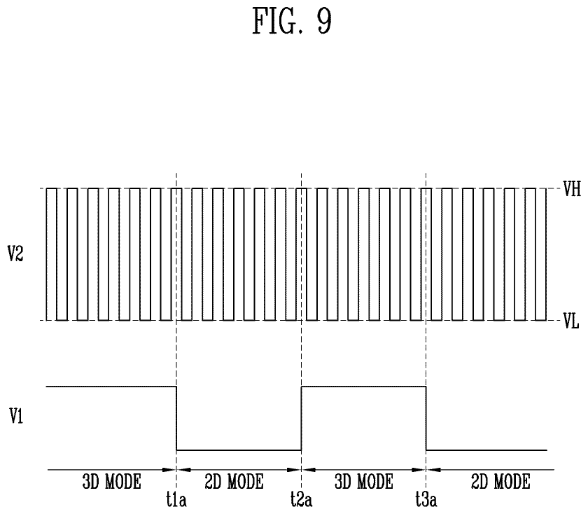

Referring to FIG. 9, the first voltage V1 may maintain a high level in 3D mode periods (˜t1a, t2a˜t3a), and maintain a low level in 2D mode periods (t1a˜t2a, t3a˜).

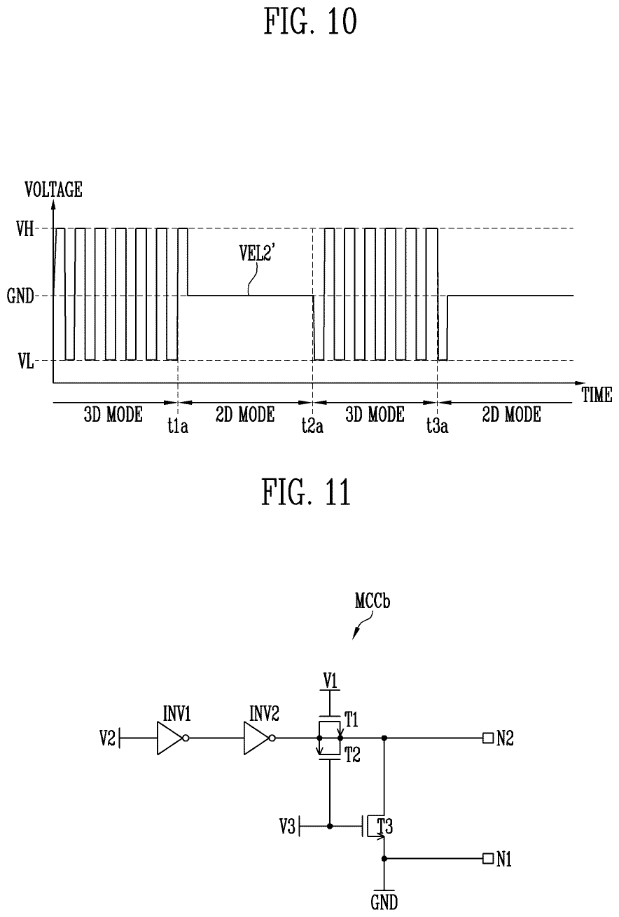

When the first voltage V1 has the high level in the 3D mode periods (˜t1a, t2a˜t3a), the first transistor B1 may be turned off, and the second transistor B2 may be turned on. Accordingly, the second voltage V2 may be applied to the second node N2 through the second transistor B2. Referring to FIG. 10, it can be seen that, during the 3D mode periods (˜t1a, t2a˜t3a), a voltage VEL2′ of the second electrode EL2 is substantially equal to the second voltage V2.

In various embodiments, when the first voltage V1 has the low level in the 2D mode periods (t1a˜t2a, t3a˜), the first transistor B1 may be turned on, and the second transistor B2 may be turned off. Accordingly, the mode control circuit MCCa may allow the first node N1 and the second node N2 to be short-circuited in the 2D mode. Referring to FIG. 10, it can be seen that, just after the display device enters into the 2D mode, the voltage VEL2′ of the second electrode EL2 rapidly converges on the voltage level of the ground GND. The mode control circuit MCCa of this embodiment provides a discharge function, when the display device enters into the 2D mode, so that a delay phenomenon can be reduced or prevented, which occurs in conversion from the 3D mode to the 2D mode. The first node N1 may be electrically connected to a ground.

FIG. 11 is a diagram illustrating a mode control circuit in accordance with an embodiment of the present disclosure.

Referring to FIG. 11, the mode control circuit MCCb in accordance with an embodiment of the present disclosure may include a first inverter INV1, a second inverter INV2, a first transistor T1, a second transistor T2, and a third transistor T3. The first inverter INV1 and the second inverter INV2 may be electrically connected in series.

In various embodiments, an input terminal of the first inverter INV1 may receive a second voltage V2, and an output terminal of the first inverter INV1 may be electrically connected to an input terminal of the second inverter INV2.

In various embodiments, the input terminal of the second inverter INV2 may be electrically connected to the output terminal of the first inverter INV1, and an output terminal of the second inverter INV2 may be electrically connected to a first electrode of the first transistor T1 and a first electrode of the second transistor T2.

In various embodiments, the first inverter INV1 and the second inverter INV2 may be provided in the mode control circuit MCCb, so as to prevent flowing of a reverse current. In another embodiment, the first inverter INV1 and the second inverter INV2 may be omitted from the configuration of the mode control circuit MCCb.

In various embodiments, a base/gate electrode of the first transistor T1 may receive the first voltage V1, the first electrode of the first transistor T1 may receive a second voltage V2, and a second electrode of the first transistor T1 may be connected to a second node N2. The first electrode of the first transistor T1 may indirectly receive the second voltage V2 via the inverters INV1 and INV2, as shown in FIG. 11. In another embodiment in which the inverters INV1 and INV2 are not provided, the first electrode of the first transistor Tl may directly receive the second voltage V2.

In various embodiments, a base/gate electrode of the second transistor T2 may receive a third voltage V3, the first electrode of the second transistor T2 receive the second voltage V2, and a second electrode of the second transistor T2 may be electrically connected to the second node N2. The first electrode of the second transistor T2 may indirectly receive the second voltage V2 via the inverters INV1 and INV2 as shown in FIG. 11. In another embodiment in which the inverters INV1 and INV2 are not provided, the first electrode of the second transistor T2 may directly receive the second voltage V2.

In various embodiments, a base/gate electrode of the third transistor T3 may receive the third voltage V3, a first electrode of the third transistor T3 may be connected to the second node N2, and a second electrode of the third transistor T3 may be connected to a first node N1. The second electrode of the third transistor T3 and the first node N1 may be connected to a ground GND.

Although FIG. 11 depicts Bipolar Junction Transistors (BJT) for each of the first transistor T1, the second transistor T2, and the third transistor T3, the first transistor T1, second transistor T2, and third transistor T3 may each be a Metal Oxide Semiconductor Field Effect Transistor (MOSFET). The first transistor T1 may be an NMOS transistor, the second transistor T2 may be a PMOS transistor, and the third transistor T3 may be an NMOS transistor.

In various embodiments, the first voltage V1 and the second voltage V2, which are applied to the mode control circuit MCCb, may be equal to the first voltage V1 and the second voltage V2, which are shown in FIG. 9. The third voltage V3 may be a reversed voltage of the first voltage V1. For example, the third voltage V3 may maintain the low level during the 3D mode periods (˜t1a, t2a˜t3a), and maintain the high level during the 2D mode periods (t1a˜t2a, t3a˜).

In various embodiments, the first transistor T1 and the second transistor T2 may be simultaneously turned on during the 3D mode periods (˜t1a, t2a˜t3a), so that the second voltage V2 can be transferred to the second node N2. By a structure in which the first transistor, as the NMOS transistor, and the second transistor T2, as the PMOS transistor, are connected in parallel, distortion of the waveform of the second voltage V2 can be prevented.

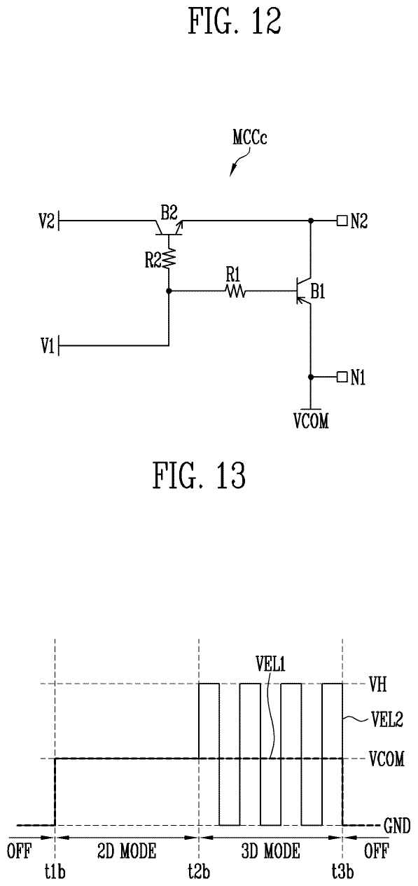

FIGS. 12 to 14 are diagrams illustrating mode control circuits in accordance with still other embodiments of the present disclosure.

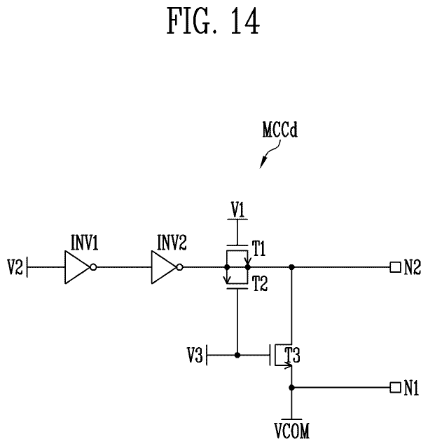

In various embodiments, a mode control circuit MCCc shown in FIG. 12 is different from the mode control circuit MCCa shown in FIG. 8, in that a voltage source different from the ground GND is connected to the first node N1. Referring to FIG. 13, a voltage VEL1 of the first electrode EL1 and a voltage VEL2 of the second electrode EL2 are exemplarily illustrated.

In various embodiments, the voltage source may supply a voltage VCOM having a voltage level higher than the voltage level of the ground GND during the 3D mode periods (˜t1a, t2a˜t3a) and the 2D mode periods (t1a˜t2a, t3a˜). The voltage level of the voltage VCOM may be equal to the voltage level of the ground GND during a turn-off period OFF of the display device 10. The voltage level of the voltage supplied from the voltage source may be equal to the voltage level of the ground GND in a turn-off state of the display device.

In various embodiments, a high level voltage VH of the second voltage V2 may be higher than the voltage level of the voltage VCOM, and a low level voltage of the second voltage V2 may be lower than the voltage level of the voltage VCOM. Therefore, a high level voltage VH of the voltage VEL2 of the second electrode EL2 may be higher than the voltage level of the voltage VCOM, and a low level voltage of the voltage VEL2 of the second electrode EL2 may be lower than the voltage level of the voltage VCOM.

For example, the low level voltage of the second voltage V2 may be equal to the voltage level of the ground GND. Therefore, the low level voltage of the voltage VEL2 of the second electrode EL2 may be equal to the voltage level of the ground GND.

In various embodiments, the first voltage V1 may be provided identically to the case shown in FIG. 9, and therefore, overlapping descriptions will be omitted.

In various embodiments, a mode control circuit MCCd shown in FIG. 14 is different from the mode control circuit MCCb shown in FIG. 11, in that a voltage source different from the ground GND is connected to the first node N1. A driving waveform is equal to the case shown in FIG. 13. As described above with reference to FIG. 11, the third voltage may be a reversed voltage of the first voltage V1.

In accordance with the embodiments shown in FIGS. 12 to 14, as a voltage source different from the ground GND is connected to the first node N1, the mode control circuit MCCc or MCCd can be prevented from having influence on the voltage level of the ground GND. In general, because the ground GND of the display device 10 is shared even by the display panel DP, the display quality of the display device 10 may be deteriorated when the voltage level of the ground GND fluctuates. Thus, the voltage VCOM is supplied using a voltage source (e.g., a Power Management Integrated Circuit (PMIC)) separate from the ground GND, so that deterioration of the display quality of the display device 10 can be prevented.

In accordance with the present disclosure, the display device can reduce or prevent a delay phenomenon occurring in conversion from the 3D mode to the 2D mode.

Example embodiments have been disclosed herein, and although specific terms are employed, they are used and are to be interpreted in a generic and descriptive sense and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A display device comprising:
a first electrode;
a liquid crystal layer located on the first electrode;
a second electrode located on the liquid crystal layer;
a lens array located on the second electrode; and
a control circuit including a first node electrically connected to the first electrode and a second node electrically connected to the second electrode,
wherein, in a first mode, the control circuit is configured to apply a first node voltage to the first node, and is configured to apply a second node voltage to the second node, wherein the second node voltage alternates between a high level voltage higher than a voltage level of the first node voltage and a low level voltage lower than the voltage level of the first node voltage, and
wherein, in a second mode, the control circuit is configured to short-circuit the first node and the second node.

2. The display device of claim 1, wherein the first mode is a three-dimensional (3D) mode, and
the second mode is a two-dimensional (2D) mode.

3. The display device of claim 1, wherein the control circuit includes:
a first resistor including a first electrode configured to receive a first voltage;
a second resistor including a first electrode configured to receive the first voltage;
a first transistor including a base/gate electrode electrically connected to a second electrode of the first resistor, a first electrode electrically connected to the second node, and a second electrode electrically connected to the first node; and
a second transistor including a base/gate electrode electrically connected to a second electrode of the second resistor, a first electrode configured to receive a second voltage, and a second electrode electrically connected to the second node.

4. The display device of claim 3, wherein each of the first transistor and the second transistor is a Bipolar Junction Transistor (BJT).

5. The display device of claim 4, wherein the first transistor is a PNP transistor, and
the second transistor is an NPN transistor.

6. The display device of claim 5, wherein the first node is connected to a ground.

7. The display device of claim 5, wherein the first node is connected to a voltage source different from a ground.

8. The display device of claim 7, wherein the voltage source is configured to supply a voltage having a voltage level higher than a voltage level of the ground in the first mode and the second mode.

9. The display device of claim 8, wherein the low level voltage of the second node voltage is equal to the voltage level of the ground, and
wherein the voltage level of the voltage supplied from the voltage source is equal to the voltage level of the ground in a turn-off state of the display device.

10. The display device of claim 3, wherein the first voltage maintains a high level voltage in the first mode and maintains a low level voltage in the second mode.

11. A display device comprising:
a first electrode;
a liquid crystal layer on the first electrode;
a second electrode on the liquid crystal layer;
a first node electrically connected to the first electrode;
a second node electrically connected to the second electrode; and
a control circuit, wherein the control circuit includes:
a first transistor including a base/gate electrode configured to receive a first voltage, a first electrode configured to receive a second voltage, and a second electrode electrically connected to the second node,
a second transistor including a base/gate electrode configured to receive a third voltage, a first electrode configured to receive the second voltage, and a second electrode electrically connected to the second node; and
a third transistor including a base/gate electrode configured to receive the third voltage, a first electrode electrically connected to the second node, and a second electrode electrically connected to the first node,
wherein, in a first mode, the control circuit is configured to apply a first node voltage to the first node, and is configured to apply a second node voltage to the second node,
wherein the second node voltage alternates between a high level voltage higher than a voltage level of the first node voltage and a low level voltage lower than the voltage level of the first node voltage, and
wherein, in a second mode, the control circuit is configured to short-circuit the first node and the second node.

12. The display device of claim 11, wherein the control circuit further includes:
a first inverter including an input terminal configured to receive the second voltage; and
a second inverter including an input terminal electrically connected to an output terminal of the first inverter, and an output terminal electrically connected to the first electrode of the first transistor and the first electrode of the second transistor.

13. The display device of claim 11, wherein each of the first transistor, the second transistor, and the third transistor is a Metal Oxide Semiconductor Field Effect Transistor (MOSFET).

14. The display device of claim 13, wherein the first transistor is an NMOS transistor,
the second transistor is a PMOS transistor, and
the third transistor is an NMOS transistor.

15. The display device of claim 14, wherein the first node is electrically connected to a ground.

16. The display device of claim 14, wherein the first node is electrically connected to a voltage source different from a ground.

17. The display device of claim 16, wherein the voltage source configured to supply a voltage having a voltage level higher than a voltage level of the ground in the first mode and the second mode.

18. The display device of claim 17, wherein the low level voltage of the second node voltage is equal to the voltage level of the ground, and
wherein the voltage level of the voltage supplied from the voltage source is equal to the voltage level of the ground in a turn-off state of the display device.

19. The display device of claim 14, wherein the third voltage is a reversed voltage of the first voltage.

20. A display device comprising:
a first electrode;
a liquid crystal layer on the first electrode;
a second electrode on the liquid crystal layer;
a first node electrically connected to the first electrode;
a second node electrically connected to the second electrode; and
a control circuit, wherein the control circuit includes:
a first transistor including a base/gate electrode configured to receive a first voltage, a first electrode configured to receive a second voltage, and a second electrode electrically connected to the second node,
a second transistor including a base/gate electrode configured to receive a third voltage, a first electrode configured to receive the second voltage, and a second electrode electrically connected to the second node; and
a third transistor including a base/gate electrode configured to receive the third voltage, a first electrode electrically connected to the second node, and a second electrode electrically connected to the first node,
wherein, in a first mode, the control circuit is configured to apply a first node voltage to the first node, and is configured to apply a second node voltage to the second node,
wherein the second node voltage alternates between a high level voltage higher than a voltage level of the first node voltage and a low level voltage lower than the voltage level of the first node voltage, and
wherein, in a second mode, the control circuit is configured to short-circuit the first node and the second node, and
wherein the first voltage maintains a high level voltage in the first mode and maintains a low level voltage in the second mode.
